(19) United States
(12) Patent Application Publication
(10) Pub. No.: US 2016/0282654 A1
(43) Pub. Date: Sep. 29, 2016

(54) LIQUID CRYSTAL PANELS AND MANUFACTURING METHODS THEREOF

(71) Applicant: SHENZHEN CHINA STAR OPTOELECTRONICS TECHNOLOGY CO., LTD, Shenzhen, Guangdong (CN)

(72) Inventor: Yanfeng FU, Shenzhen, Guangdong (CN)

(21) Appl. No.: 14/413,148

(22) PCT Filed: Jan. 17, 2014
(86) PCT No.: PCT/CN2014/070810

§ 371 Date: Jan. 6, 2015

(30) Foreign Application Priority Data
Dec. 20, 2013 (CN) 201310719636.7

(51) Int. Cl. G02F 1/1339

(52) U.S. Cl. CPC G02F 1/13394

(57) ABSTRACT

The present invention provides a liquid crystal panel, which includes a first substrate and a second substrate, a supporting pole disposed between two substrates and pads disposed on a facing substrate, and stoppers set between the supporting pole and the pads for limiting in different directions to prevent relative movement of the substrates. The stoppers are disposed on the pads in at least two directions to cooperate with the supporting pole and to limit the supporting pole in different directions, thereby preventing to displace left and right, back and forth between the two substrates and problem of light leakage.

### FIELD OF THE INVENTION

The present invention relates to liquid crystal panels and manufacturing methods thereof, and more particular, refers to liquid crystal panels and manufacturing methods by which pads can be adjusted by limit adjustment.

### BACKGROUND OF THE INVENTION

Conventional liquid crystal displays, as shown in reference to FIG. 1, generally provided with a color filter substrate, an array substrate and pads disposed between the color filter substrate and the array substrate, multi layers are formed on the color film substrate and the array substrate by coating process. The pads support a liquid crystal housing to make its central vacant. However, as an outer surface of the liquid crystal panel, the color filter substrate is easily deformed when it is in certain compressed state, so that certain shift of the pads may occur, which causes light leakage on the liquid crystal panel.

### SUMMARY OF THE INVENTION

On account of the lack of the prior art, the object of the present invention is to provide liquid crystal panel structures and manufacturing methods thereof by which position of supporting pole can be limited, thus to avoid light leakage by movement of the supporting pole under certain pressure.

The present invention provides a liquid crystal panel including a first substrate and a second substrate, a supporting pole disposed between the two substrates and pads disposed on a facing substrate, and a stopper set between the supporting pole and the pads for limiting them in different directions to prevent relative movement of the substrates.

Preferably, the stopper includes a first stopper positioned in a first direction and a second stopper positioned in a second direction, the first stopper includes a first groove and a corresponding first protrusion, the first groove is disposed on the pads or the supporting pole, correspondingly, the first protrusion is disposed on the supporting pole or the pads, the first protrusion is engaged into the first groove to limit in a first direction. In another way, the first groove is disposed on the pads, and the first protrusion is an end of the supporting pole contacting with the pads and is engaged into the first groove. The supporting pole is limited by disposing the stopper in different directions, thereby preventing its movement left and right.

Preferably, the stopper includes a first stopper limiting in a first direction and a second stopper limiting in a second direction. The second stopper includes a second groove and a second protrusion cooperating with said second groove. The second groove is disposed on the pads or the supporting pole, correspondingly, the second protrusion is disposed on the supporting pole or the pads, the second protrusion is engaged into the first groove to limit in a second direction. The second groove is disposed on central of an end of the supporting pole contacting with the pads. The second protrusion is disposed on the pads correspondingly to the second groove. The second protrusion is engaged into the second groove.

Preferably, the stopper includes a first stopper limiting in a first direction and a second stopper limiting in a second direction. The first direction and the second direction intersect perpendicularly to each other. The first stopper includes a first groove and a first protrusion cooperating with the first groove, the first protrusion is engaged into the second groove and limits in the first direction; the second stopper includes a second groove and a second protrusion cooperating with the second groove, the second protrusion is engaged into the second groove and limits in the second direction; the first groove is set on the pads, and said first protrusion is an end of the supporting pole contacting with the pads, the end of said supporting pole is engaged into the first groove; the second groove is set in central of an end of the supporting pole, the second protrusion is set on bottom inside of the first groove on the pads corresponding to the second groove, the second protrusion is engaged into the second groove. The supporting pole is limited in multiple directions by disposing the stoppers along different directions, thereby preventing displacement thereof.

Preferably, the first substrate is a color film substrate, and the second substrate is an array substrate. Vice versa. The pads of the second substrate includes, in order from bottom to top of the structure, a gate metal layer, a silicon oxide layer, an antifouling layer, a source-drain metal layer and a passivation layer silicon nitride layer; wherein a second protrusion is formed in an area of the passivation layer silicon nitride layer corresponding to central of an end of the supporting pole.

The present invention also provides a manufacturing method of a liquid crystal panel, comprises:

Step 1) forming a supporting pole and pads on a first substrate and a second substrate, exposing, developing and baking to the pads or the supporting pole by a photomask to form a stopper between the supporting pole and the pads to limit them in different directions;

Step 2) engaging the first substrate and the second substrate to achieve the limit function of the stopper between the supporting pole or the pads.

Compared with the prior art, the liquid crystal panel structure of the present invention, wherein the first substrate and the second substrate are connected by the supporting pole and the pads, and the stoppers are disposed on the pads in at least two directions to cooperate with the supporting pole and to limit the supporting pole in different directions, thereby preventing to displace left and right, back and forth between the two substrates and problem of light leakage. The stopper has a plurality combining forms, such as a groove or a protrusion may be provided on both sides of the supporting pole to limit the sides of the supporting pole, or, a groove or a protrusion may be provided in the middle of the pads to be engaged respectively with the protrusion and the groove of the supporting pole to strengthen the central limit of the supporting pole, thereby achieving the limit to the supporting pole by multi-point and multi-faceted. At the time, it also provides a molding method of the liquid crystal panel. The liquid crystal panel is formed by passing through a semi-permeable photomask to expose and develop into an area of the stopper, the molding method is simple, it doesn't need to cut the films on the substrates and consequently to damage them, so that the whole liquid crystal panel has good imaging performance, thereby solving the problem of light leakage due to the pressure on the liquid crystal panel surface.

### BRIEF DESCRIPTION OF THE DRAWINGS

FIG. 1 is a side view of a conventional liquid crystal panel;

FIG. 2 is a top view of a liquid crystal panel of a first embodiment of the invention;

FIG. 3 is a sectional view taken along a direction A-A of FIG. 2;

FIG. 4 is a sectional view taken along a direction B-B of FIG. 2;

FIG. 5 is a plan view of a liquid crystal panel of a second embodiment of the invention;

FIG. 6 is a sectional view taken along a direction B-B of FIG. 5; and

FIG. 7 is a molding schematic drawing according to a manufacturing method of liquid crystal panels of the invention.

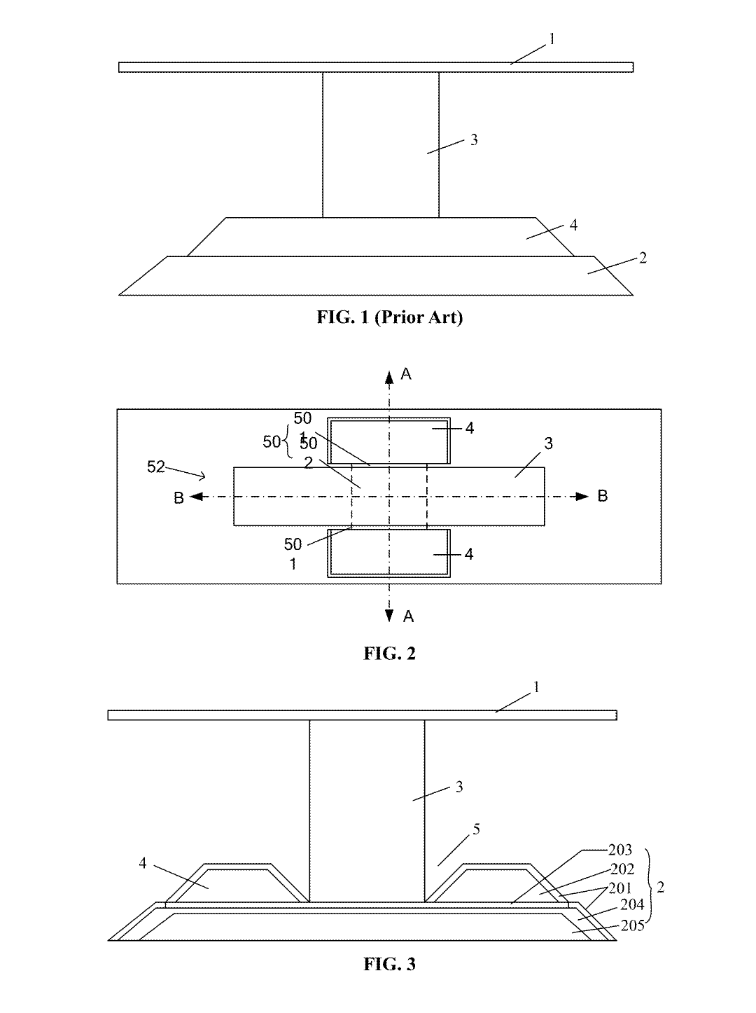

### DETAILED DESCRIPTION OF THE PREFERRED EMBODIMENTS

Please refer to FIGS. 2 and 3, the present invention provides a liquid crystal panel structure, which includes a first substrate 1 and a second substrate 2, a supporting pole 3 set between the two substrates and pads 4 disposed on a facing substrate, and a stopper 5 set between the supporting pole 3 and the pads 4 for limiting in different directions to prevent relative movement of the substrates. The pads 4 are disposed on the second substrate 2 for limiting and fixing the supporting pole 3. The supporting pole 3 supports the first substrate 1, and a certain thickness is formed thereon by the supporting of the supporting pole 3 between the first substrate 1 and the second substrate 2, and the thickness may be held when there is certain pressure occurred on the first substrate 1.

The stopper 5 is disposed in different directions relative to the pads 4, and the pad 4 is prevented to displace in different directions by the limit of the stopper 5 in at least two directions, thereby avoiding relative displacement between the first substrate 1 and the second substrate 2. The stopper 5 includes a first stopper 50 limiting in a first direction and a second stopper 52 limiting in a second direction. Preferably, the first direction and second direction intersect perpendicularly to each other, so that the supporting pole 3 is limited in two directions that are perpendicular to each other. It will be appreciated that the first direction and second direction are not necessarily be perpendicular to each other, as long as the two directions are not parallel to each other.

The first direction and the second direction are perpendicular to each other for example, referring to FIGS. 2 and 3, a direction A-A of a first embodiment is provided along a first direction. The first stopper 50 includes a first groove 501 and a first protrusion 502 cooperating with the first groove 501, wherein an end of the supporting pole 3 contacting with the pads 4 is used as the first protrusion 502 which is engaged in the first groove 501 formed by rounding of both sides of front and rear of the pads 4. The first groove 501 extends in the first direction (direction A-A) of the pads 4 and its limit width is substantially equivalent to width of the pad 4 to limit the position of the supporting pole 3 in the direction A-A. Sidewalls of the pads 4 hold against sidewalls of the supporting pole 3 to prevent the supporting pole 3 to move back and forth, thereby limiting the support column 3 along the first direction.

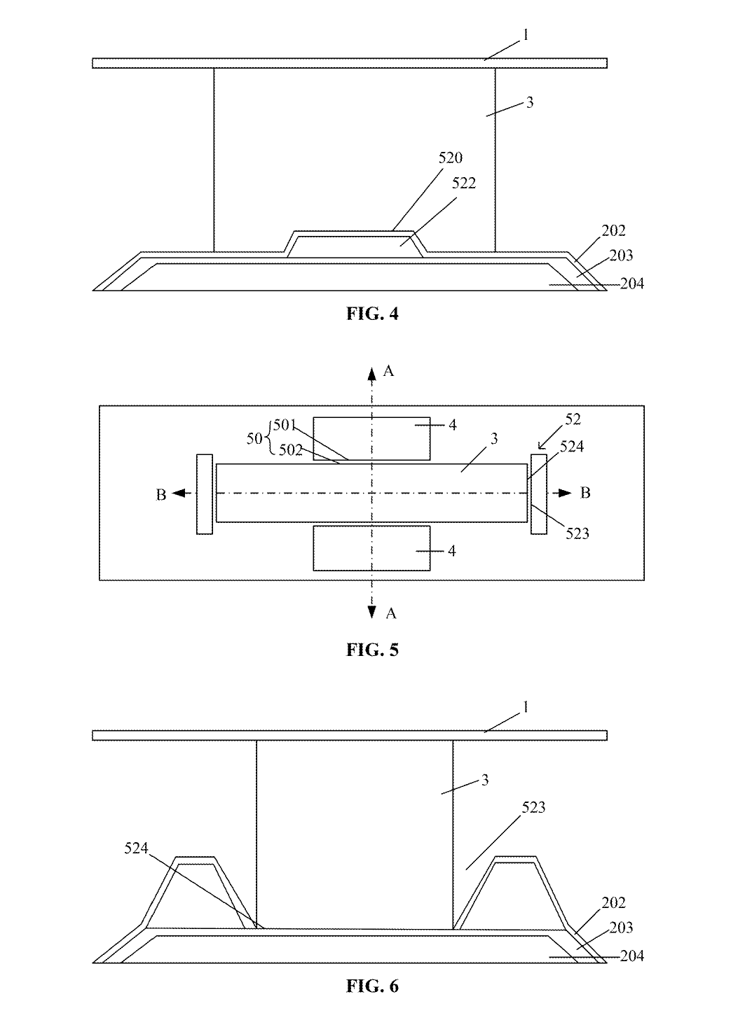

Referring to FIGS. 2 and 4, the direction B-B is provided along a second direction of the pads. The second stopper 52 includes a second groove 520 and a second protrusion 522 cooperating with the second groove 520. The second groove 520 is set at a central of an end of the supporting pole 3 contacting with the pads 4, while the second protrusion 522 is set in an area on the pads 4 corresponding to the second groove 520. The second protrusion 522 is engaged into the second groove 520, thereby avoiding the supporting pole 3 moving left and right along the second direction.

Referring to FIGS. 5 and 6, in a second embodiment, the direction B-B is provided along a second direction of the pads. The second stopper 52 also includes a second groove 523 and a second protrusion 524 cooperating with the second groove 523. The pads 4 at left and right sides of the supporting pole 3 forms the second groove 523. An end of the supporting pole 3 contacting with the pads 4 is used as a second protrusion 524 and is engaged into the second groove 523 formed by left and right sides of the pads 4. The same, the second groove 523 extends in the second direction (direction B-B) of the pads 4 and its limit width is substantially equivalent to width of the pad 4 to limit the position of the supporting pole 3 in the direction B-B. Sidewalls of the pads 4 hold against sidewalls of the supporting pole 3 to prevent the supporting pole 3 to move left and right, similarly, the limit for the support column 3 along the first direction could be achieved.

Therefore, the supporting pole can be limited in the first direction and the second direction by the different stoppers. The protrusions and the corresponding grooves are arranged at both sides of the supporting pole, and thus to limit the supporting pole in different directions by executing the limit to the two sides thereof. Further, a central limit manner can also be combined, a protrusion or a groove is provided in the middle of the pads 4 and engages respectively with those of the supporting pole to prevent the supporting pole to swing shift left and right due to certain pressure occurred on the first substrate, so that the supporting pole is more stably positioned, thereby avoiding any displacement between the first substrate and the second substrate as well as the light leakage.

In the present invention, the first substrate 1 is a color film substrate, and the second substrate 2 is an array substrate. Vice versa. When the second substrate is an array substrate, the array substrate includes, in order from bottom to top of the structure, a gate metal layer (Gate Metal) 205, a silicon oxide layer (SiNx) 204, an antifouling layer (AS-Island) 203, a source-drain metal layer (SD Metal) 202 and a passivation layer silicon nitride layer (PV—SiNx) 201. Referring to FIG. 3, the pad 4 is composed of the passivation layer silicon nitride layer 201 and the source-drain metal layer 202. The passivation layer silicon nitride layer 201 is wrapped onto outer periphery of the source-drain metal layer 202. The second substrate 2 is an array substrate and includes, in order from outside to inside, a passivation layer silicon nitride layer 201, a silicon oxide layer 204 and a gate metal layer 205, the passivation layer silicon nitride layer 201 is wrapped onto outermost layer of the second substrate 2. The antifouling layer 203 is disposed between the pad 4 and the second substrate 2. Wherein the second protrusion 522 is formed on an end of the antifouling layer 203 corresponding to the supporting pole 3.

In the preferred embodiment of the invention, as shown in FIG. 3, a first groove 501 along the direction A-A is formed between the pads 4 and the supporting column 3, the first groove 501 is formed between the supporting column 3 and the passivation layer silicon nitride layer 201 of the pads 4. Referring to FIG. 4, in the direction B-B, the second protrusion 522 projects upwardly from the antifouling layer 203, an inside of the second groove 520 is formed by passivation layer silicon nitride layer 201, the second protrusion 502 is engaged correspondingly into the second groove 520 to form the second stopper 52, thereby enhancing the limit effect in the middle of the supporting pole 3 and the pads 4.

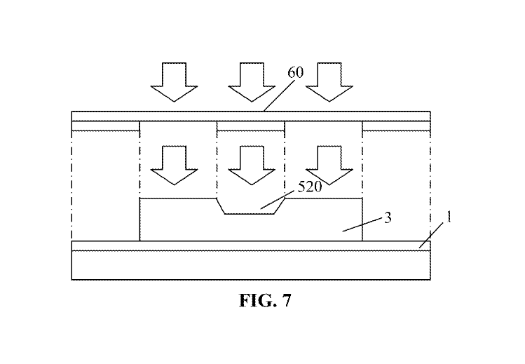

Referring to FIG. 7 in combination, the present invention also provides a manufacturing method of a liquid crystal panel, comprises:

Step 1) forming a supporting pole 3 and pads 4 on a first substrate 1 and a second substrate 2, exposing, developing and baking to the pads 4 or the supporting pole 3 by a photomask to form a stopper between the supporting pole 3 and the pads 4 to limit them in different directions;

Step 2) engaging the first substrate 1 and the second substrate 2 to achieve the limit function of the stopper executed between the supporting pole 3 or the pads 4.

Referring to FIG. 7, the photomask is a semi-permeable photomask. The FIG. 7 illustrates a schematic forming state for preparing the liquid crystal panel according to the first embodiment. A forming region of the stopper above the transparent substrate is covered with the semi-permeable photomask 60. Light passes through an area of the semi-permeable photomask 60 to form a groove by ways of exposing and developing. Exposure and development does not occur in an impermeable area where light passes through the photomask, but after partial exposure and development, a groove of the stopper 5 is formed the pads 4. In the same way, exposure and development on the protrusion's periphery may form a protrusion.

According to the liquid crystal panel structure of the present invention, the first substrate and the second substrate are connected by the supporting pole and the pads, and the stoppers are disposed on the pads in at least two directions to cooperate with the supporting pole and to limit the supporting pole in different directions, thereby preventing left and right displacement between the two substrates and problem of light leakage. The stopper has a plurality combining forms, such as a groove or a protrusion may be provided on both sides of the supporting pole to limit the sides of the supporting pole, or, a groove or a protrusion may be provided in middle of the pads to be engaged respectively with the protrusion and the groove of the supporting pole to strengthen the central limit for the supporting pole, thereby achieving the limit executed onto the supporting pole by multi-point and multi-faceted. At the time, it also provides a forming method of the liquid crystal panel, which is formed by passing through a semi-permeable photomask or a grayscale mask the light to expose and develop into an area of the stopper. The present molding method is simple, it doesn't need to cut the films on the substrates and consequently to damage them, so that the whole liquid crystal panel has good imaging performance, thereby solving the problem of light leakage due to certain pressure occurred on the liquid crystal panel surface.

What is claimed is:

1. A liquid crystal panel, comprising a first substrate and a second substrate, a supporting pole disposed between said two substrates, pads disposed on a facing substrate, and a stopper disposed between the supporting pole and the pads for limiting them in different directions to prevent relative movement of the substrates, the stopper comprises a first stopper positioned in a first direction and a second stopper positioned in a second direction, said first stopper comprises a first groove and a first protrusion cooperating with the first groove, said first groove is disposed on the pads or the supporting pole, correspondingly, the first protrusion is disposed on the supporting pole or the pads, said first protrusion is engaged into the first groove to execute said limit thereof.

2. The liquid crystal panel according to claim 1, wherein said first groove is disposed on the pads, said protrusion is an end of said supporting pole contacting with the pads and is engaged into said first groove.

3. The liquid crystal panel according to claim 2, wherein said second stopper comprises a second protrusion and a second groove cooperating with said second protrusion, said second groove is disposed on said pads or said supporting pole, said second protrusion is correspondingly disposed on said supporting pole or said pads, said second protrusion is engaged into the second groove to execute the limit in a second direction.

4. The liquid crystal panel according to claim 3, wherein said second groove is disposed on a central of an end of said supporting pole contacting with said pads, said second protrusion is disposed on the pads corresponding to said second groove, said second protrusion is engaged into the second groove.

5. The liquid crystal panel according to claim 1, wherein said first direction and said second direction intersect perpendicularly to each other, said first stopper comprises a first groove and a first protrusion cooperating with said first groove, said first protrusion is engaged into said second groove and limits in a first direction; said second stopper comprises a second groove and a second protrusion cooperating with said second groove, said second protrusion is engaged into the second groove and limits in a second direction; said first groove is disposed on the pads, and said first protrusion is an end of the supporting pole contacting with the pads, the end of said supporting pole is engaged into the first groove; said second groove is disposed on a central of an end of the supporting pole, said second protrusion is disposed on bottom inside of the first groove on the pads corresponding to the second groove, said second protrusion is engaged into the second groove.

6. The liquid crystal panel according to claim 1, wherein said pads of said second substrate comprises, in order from bottom to top of the structure, a gate metal layer, a silicon oxide layer, an antifouling layer, a source-drain metal layer and a passivation layer silicon nitride layer; wherein a second protrusion is formed in an area of the passivation layer silicon nitride layer corresponding to a central end of the supporting pole.

7. The liquid crystal panel according to claim 1, wherein said stopper comprises a protrusion and a corresponding groove disposed between the supporting pole and the pads and execute the limit in two directions perpendicular to each other.

8. A liquid crystal panel, comprising a first substrate and a second substrate, a supporting pole disposed between said two substrates and pads disposed on a facing substrate, wherein a stopper is disposed between the supporting pole and the pads for limiting in different directions to prevent relative movement of the substrates.

9. The liquid crystal panel according to claim 8, wherein, the stopper comprises a first stopper positioned in a first direction and a second stopper positioned in a second direction, said first stopper comprises a first groove and a corresponding first protrusion, said first groove is disposed on the pads or the supporting pole, correspondingly, the first protrusion is disposed on the supporting pole or the pads, said first protrusion is engaged into the first groove to execute the limit.

10. The liquid crystal panel according to claim 9, wherein said first groove is disposed on the pads, said protrusion is an end of said supporting pole contacting with the pads and is engaged into said first groove.

11. The liquid crystal panel according to claim 8, wherein said stopper comprises a first stopper positioned in a first direction and a second stopper positioned in a second direction, said second stopper comprises a second groove and a corresponding second protrusion, said second groove is disposed on the pads or the supporting pole, correspondingly, the second protrusion is disposed on the supporting pole or the pads, said second protrusion is engaged into the second groove to execute the limit.

12. The liquid crystal panel according to claim 11, wherein said second groove is disposed on a central of an end of said supporting pole contacting with said pads, said second protrusion is disposed on the pads corresponding to said second groove, said second protrusion is engaged into said second groove.

13. The liquid crystal panel according to claim 8, wherein said stopper comprises a first stopper positioned in a first direction and a second stopper positioned in a second direction, said first direction and said second direction intersect perpendicularly to each other, said first stopper comprises a first groove and a corresponding first protrusion, said first protrusion is engaged into the first groove to execute the limit; said second stopper comprises a second groove and a second protrusion cooperating with said second groove, said second protrusion is engaged into the second groove and limits in a second direction; said first groove is set on the pads, and said first protrusion is an end of the supporting pole contacting with the pads, the end of said supporting pole is engaged into the first groove; said second groove is disposed on a central of an end of the supporting pole, said second protrusion is disposed on bottom inside of the first groove on the pads corresponding to the second groove, said second protrusion is engaged into the second groove.

14. The liquid crystal panel according to claim 8, wherein said pads of said second substrate comprises, in order from bottom to top of the structure, a gate metal layer, a silicon oxide layer, an antifouling layer, a source-drain metal layer and a passivation layer silicon nitride layer; wherein a second protrusion is formed in an area of the passivation layer silicon nitride layer corresponding to a central of an end of the supporting pole.

15. The liquid crystal panel according to claim 8, wherein said stopper comprises a protrusion and a corresponding groove disposed between the supporting pole and the pads and limit them in two directions perpendicular to each other.

16. A manufacturing method of a liquid crystal panel, comprising:
Step 1) forming a supporting pole and pads on a first substrate and a second substrate, exposing, developing and baking onto the pads or the supporting pole by a photomask to form a stopper between the supporting pole and the pads to execute limit in different directions; and
Step 2) engaging the first substrate and the second substrate to achieve the limit function for the stopper between the supporting pole and the pads.

17. The manufacturing method of a liquid crystal panel according to claim 16, wherein said stopper comprises a first stopper positioned in a first direction and a second stopper positioned in a second direction, said first direction and said second direction intersect perpendicularly to each other, said first stopper comprises a first groove and a corresponding first protrusion, said first protrusion is engaged into the first groove to execute the limit; said second stopper comprises a second groove and a second protrusion cooperating with said second groove, said second protrusion is engaged into the second groove and limits in a second direction; said first groove is disposed on the pads, and said first protrusion is an end of the supporting pole contacting with the pads, the end of said supporting pole is engaged into the first groove; said second groove is disposed on central of an end of the supporting pole, said second protrusion is set on bottom inside of the first groove on the pads corresponding to the second groove, said second protrusion is engaged into the second groove; wherein said second groove is formed by passing through a semi-permeable photomask to expose and develop onto said supporting pole.
